(19) United States
(12) Patent Application Publication
(10) Pub. No.: US 2025/0011572 A1
(43) Pub. Date: Jan. 9, 2025

(54) COMPOSITION FOR USE IN RELEASE LINERS

(71) Applicant: SABIC GLOBAL TECHNOLOGIES B.V., Bergen op Zoom (NL)

(72) Inventors: Niclasina Siberta Johanna Alberdina GERRITS, Sittard (NL); Bernardus Aldegonda Josephus RAVEN, Oirsbeek (NL); Karel WILSENS, Veldhoven (NL); Sarah MIERLOO VAN, Opglabbeek (BE)

(21) Appl. No.: 18/711,927

(22) PCT Filed: Nov. 23, 2022
(86) PCT No.: PCT/EP2022/083022

§ 371 Date: May 21, 2024

(30) Foreign Application Priority Data
Dec. 3, 2021 (EP) 21212342.6

(51) Int. Cl. C08K 5/1545; B32B 27/08; B32B 27/10; B32B 27/18; B32B 27/28; B32B 27/32; B32B 37/18

(52) U.S. Cl. CPC C08K 5/1545; B32B 27/08; B32B 27/10; B32B 27/18; B32B 27/283; B32B 27/32; B32B 37/182; B32B 2250/03; B32B 2323/04; B32B 2383/00

(57) ABSTRACT

The present invention relates to a composition comprising: a) a polyethylene having a density of ≥940 and ≤970 kg/m³ as determined in accordance with ASTM D792 (2008); and b) ≥10 and ≤100, preferably ≥20 and ≤50, ppm of α-tocopherol, with regard to the total weight of the composition. Such composition contributes, when used in a laminate comprising a paper layer, a layer of the composition and a layer comprising a curable silicone resin formulation, to an improved cross-linking content upon curing of the curable silicone resin formulation, whilst demonstrating appropriate adhesion to the paper layer.

The present invention relates to a composition for use in release liners. The invention further relates to a process for manufacture of release liners, and to a release liner.

Release liners are typically sheets that are used to protect a sticky surface, such as an adhesive surface, from prematurely adhering, i.e. from adhering to an object prior to being intended so. Examples of objects comprising such sticky surface which require protection are ubiquitous; a particular example are adhesive labels, or stickers, but also articles like adhesive medical plasters are notable examples of objects where a release liner is used to prevent the adhesive surface of the object to come into contact with another object and thereby losing its adhesive properties prematurely.

The release liners that are suitable for use as protective liner for adhesive surfaces typically are of such nature that they do stick to the adhesive surface, however in such fashion that they do not react with the material of the adhesive layer in such way that the adhesive function is affected nor that the adhesive layer is, partly or in full, removed from the object when the release liner is removed for final use. Furthermore, it is required that the release liner itself will not tear when removed, i.e. the tear strength of the release liner should be greater than the adhesive force between the release liner and the adhesive layer. Next to that, the release liner needs to be sufficiently rigid for it to be easily possible to pick up and remove the object such as the label from the release liner. In particular where the objects are positioned on for example a roll, the release liner needs to be sufficiently rigid to allow such roll to be formed and retain its structure.

In order for the release liner to comply with the above requirements, laminate structures are often suitable solutions. In such laminate structure, several layers or films of material may be present that each contribute in their own way to achieving the desired properties of the release liner.

Typically, the top layer, i.e. the layer of the release liner that is in contact with the adhesive layer of the object that is to be protected, is a layer that comprises or consists of a material that has a low surface energy. Particularly suitable for this purpose are cross-linked silicone layers.

Commonly, the release liner laminate may comprise a second layer that is in contact with the top layer via the second surface of the top layer, i.e. that surface of the top layer that is not in contact with the adhesive layer of the object to be protected. The second layer may for example serve to provide tear resistance properties to the laminate. This second layer may for example comprise or consist of a thermoplastic polymer composition. The second layer serves amongst others to contribute to the flexibility, elasticity and tear resistance of the release liner laminate.

Further commonly, the release liner laminate may comprise a third layer, which forms part of the laminate at the side of the surface of the second layer that is not in contact with the top layer. This third layer may contribute to the properties of the release liner laminate by for example adding to the rigidity of the laminate. Examples of materials used in such third layer include paper or metal foils, for example aluminium foils.

The paper that may suitably be used as the third layer may for example be a kraft paper, a calendared kraft paper, a machine finished kraft paper, or a machine glazed paper.

The third layer may be in direct contact with the second surface of the second layer, i.e. the surface of the second layer that is not in contact with the top layer, or there may be further layers positioned between the second layer and the third layer. Accordingly, a release liner laminate may have a structure A/B/C, wherein C is the top layer, B is the second layer, and A is the third layer; alternatively, further layers may be present between B and C. A laminate structure A/B/C is a typical example of a release liner laminate.

The thermoplastic polymer composition that is used for the second layer commonly comprises polyethylene materials. Polyethylene materials are abundantly available, and very suitable to make flexible, tough, elastic, thin films.

The various layers of material that are used to combine into a release liner of proper quality need, each individually and together, comply with certain product requirements. A particular requirement for the second layer is that it may not comprise compounds in any extent that could result in migration into the top layer and in that layer affecting the properties of that top layer. In particular, no compounds may migrate into the top layer that detrimentally affect the curing or cross-linking degree of the material of the top layer.

In a typically employed process for manufacturing of release liners, the laminate is produced by combining the appropriate layers into a laminate structure wherein the top layer silicone material is provided in an uncured form, which is then subsequently subjected to curing to obtain the release liner that is then suitable for use in its protective application.

In the context of the present invention, ‘curing’ and ‘cross-linking’ are interchangeable.

In order for the top layer to be curable, it commonly is applied to the laminate as a silicone formulation. For example, such formulation may comprise a silicone compound, such as a polyvinylsiloxane, a cross-linker and a catalyst for the cross-linking process. It has been found that certain polyethylene compositions that may be used in the second layer comprise compounds that detrimentally affect the catalytic activity of the catalyst that is used in the silicone curing process. Such phenomenon may particularly be applicable when the silicone curing process involves cross-linking, for example when a Pt-containing catalyst is used in such curing process. This leads to incomplete curing, and the formation of a top layer of inferior quality. Alternatively, an excessive quantity of catalyst is to be used to achieve the desired level of curing. This is not desirable.

Accordingly, there is a need for providing a material that is suitable for use as a second layer in a release liner wherein the curing of the silicone top layer of the release liner is not detrimentally affected by the material of the second layer.

This is now provided according to the invention by a composition comprising:
a) a polyethylene having a density of ≥940 and ≤970 kg/m3 as determined in accordance with ASTM D792 (2008); and
b) ≥10 and ≤100, preferably ≥20 and ≤50, ppm of α-tocopherol, with regard to the total weight of the composition.

Such composition contributes, when used in a laminate comprising a paper layer, a layer of the composition and a layer comprising a curable silicone resin formulation, to an improved cross-linking content upon curing of the curable silicone resin formulation, whilst demonstrating appropriate adhesion to the paper layer.

The polyethylene a) may for example be a homopolymer of ethylene or a copolymer of ethylene and one or more α-olefins selected from 1-butene, 1-hexene, 4-methyl-1-pentene and 1-octene. Preferably, the polyethylene a) comprises ≤5.0 wt % of moieties derived from α-olefins selected from 1-butene, 1-hexene, 4-methyl-1-pentene and 1-octene, more preferably ≥0.1 and ≤5.0 wt %, even more preferably ≥0.2 and ≤3.0 wt %, with regard to the total weight of the polyethylene a).

The content of moieties derived from α-olefins selected from 1-butene, 1-hexene, 4-methyl-1-pentene and 1-octene may be determined via ¹³C NMR spectrometry according to the method presented in JAPS, Vol. 42, pp. 399-408, 1991.

It is preferred that the composition comprises in total ≤5 ppm, preferably ≤2 ppm, of phosphorous-containing compounds, more preferably the composition is essentially free from phosphorous-containing compounds.

The composition may in certain embodiments further comprise:
c) a low-density polyethylene (LDPE) having a density of ≥900 and ≤935 kg/m³ as determined in accordance with ASTM D792 (2008), preferably of ≥915 and ≤930 kg/m³, more preferably of ≥920 and ≤930 kg/m³.

The composition may for example comprise ≥5.0 and ≤50.0 wt %, preferably ≥10.0 and ≤35.0 wt %, more preferably ≥10.0 and $20.0 wt % of the LDPE, with regard to the total weight of the composition.

The LDPE may for example have a melt mass-flow rate as determined in accordance with ISO 1133:2005 at 190° C. and 2.16 kg load of ≥1.0 and ≤15.0 g/10 min, preferably ≥1.5 and ≤10.0 g/10 min, more preferably ≥1.5 and ≤5.0 g/10 min.

In certain embodiments, the composition may comprise ≥50.0 wt %, preferably ≥60.0 wt %, preferably ≥75.0, and ≤99.93 wt %, of the polyethylene a), with regard to the total weight of the composition.

It is preferred that the polyethylene a) has a density of ≥945 and ≤970 kg/m³, more preferably of ≥950 and ≤970 kg/m³, even more preferably of ≥955 and ≤970 kg/m³, yet even more preferably of ≥955 and ≤965 kg/m³.

The polyethylene a) may for example have a melt mass-flow rate as determined in accordance with ISO 1133:2005 at 190° C. and 2.16 kg load of ≥1.0 and ≤15.0 g/10 min, preferably ≥3.0 and ≤10.0 g/10 min, more preferably ≥5.0 and ≤10.0 g/10 min.

The invention further relates to a laminate comprising in this order:
A) a paper layer;
B) a layer comprising the composition according to the invention; and
C) a layer comprising a curable silicone resin formulation.

The paper may for example be a kraft paper, a calendared kraft paper, a machine finished kraft paper, or a machine glazed paper.

Preferably, the paper has a grammage of ≥25 and ≤200 g/m², more preferably of ≥40 and ≤150 g/m², even more preferably of ≥50 and ≤100 g/m².

Preferably, the layer B) has a grammage of ≥5 and ≤50 g/m², more preferably of ≥10 and ≤40 g/m², even more preferably of ≥10 and ≤30 g/m².

Preferably, the layer C) has a grammage of ≥0.1 and ≤5.0 g/m², more preferably of ≥ 0.5 and ≤5.0 g/m², even more preferably of ≥0.5 and ≤3.0 g/m².

In the context of the present invention, skilled person will understand the grammage to indicate the weight of the particular layer per sample of 1 m² of such layer.

The curable silicone resin formulation may for example comprise a silicone resin, a cross-linking agent and a cross-linking catalyst.

The cross-linking agent may for example be a hydropolysiloxane, for example a hydropolysiloxane comprising alkylhydrosiloxy moieties, preferably a hydropolysiloxane comprising methylhydrosiloxy moieties.

For example, the cross-linking agent may comprise alkylhydrosiloxy moieties and dialkylsiloxy moieties. Preferably, the cross-linking agent comprises methylhydrosiloxy moieties and dimethylsiloxy moieties.

The cross-linking catalyst may for example comprise a platinum-containing complex, for example selected from hexachloroplatinic acid and Pt₂[(Me₂SiCHCH₂)₂O]₃.

The silicone resin may for example be a polysiloxane, for example a linear or branched polysiloxane, preferably wherein the polysiloxane comprises dialkylsiloxy moieties, preferably dimethylsiloxy moieties, and preferably wherein the polysiloxane comprises vinyldimethylsiloxy terminal moieties. The polysiloxane may for example comprise on average between 50 and 250 repeating dialkylsiloxy moieties.

The alkyl moieties that may be used in the silicone resin and the cross-linking agent may for example be moieties comprising 1-6 carbon atoms. They may be linear or branched. For example, such alkyl moiety may be a methyl, ethyl, n-propyl, isopropyl, n-butyl, isobutyl, n-pentyl, or n-hexyl moiety.

The invention further also relates to a process for the manufacturing of a cured laminate comprising:
(i) providing a laminate comprising in this order:
   A) a paper layer;
   B) a layer comprising the composition according to the invention; and
   C) a layer comprising a curable silicone resin formulation;
and
(ii) subjecting the laminate to a curing process, wherein the curing process involves subjecting the laminate to a curing temperature, preferably a temperature of ≥80° C. and ≤120° C., more preferably of ≥80° C. and ≤110° C., for a period sufficient for the curing to occur, preferably for ≥10 s and ≤120 s, more preferably for ≥10 s and ≤ 60 s, even more preferably for ≥10 s and ≤30 s.

A further embodiment of the invention relates to a cured laminate comprising in this order:
A) a paper layer;
B) a layer comprising the composition according to any one of claims 1-4; and
C) a layer comprising a cured silicone resin formulation obtained by curing a curable silicone resin formulation comprising a silicone resin, a cross-linking agent and a cross-linking catalyst, wherein:
   the cross-linking agent a hydropolysiloxane, for example a hydropolysiloxane comprising alkylhydrosiloxy moieties, preferably a hydropolysiloxane comprising methylhydrosiloxy moieties;
   the cross-linking catalyst comprises a platinum-containing complex, for example selected from hexachloroplatinic acid and Pt₂[(Me₂SiCHCH₂)₂O]₃; and
   the silicone resin is a polysiloxane, for example a linear or branched polysiloxane, preferably wherein the polysiloxane comprises dialkylsiloxy moieties, preferably dimethylsiloxy moieties, and preferably wherein the polysiloxane comprises vinyldimethylsiloxy terminal moieties.

The invention also relates to a protected object, wherein the protected object comprises
an object comprising an adhesive layer; and
a cured laminate according to the invention;
wherein the adhesive layer of the object and the layer C) of the laminate are in contact with each other.

Furthermore, the invention also relates to the use of a composition comprising:
a) a polyethylene having a density of ≥940 and ≤970 kg/m³ as determined in accordance with ASTM D792 (2008); and
b) ≥10 and ≤100 ppm of α-tocopherol, with regard to the total weight of the composition;
   for improvement of the crosslinking of a curable silicone resin formulation in a process for curing a laminate comprising a layer comprising the composition and layer comprising the curable silicone resin formulation, wherein the layer comprising the composition and the layer comprising the curable silicone resin formulation are in contact with each other.

The invention will now be illustrated by the following non-limiting examples.

### Materials

| | |
|---|---|
| HDPE | SABIC HDPE F0863 |
| LDPE | SABIC LDPE 2404EC |
| AO1 | Irganox E201 |
| AO2 | Irganox 1010 |
| AO3 | Irgafos 168 |
| SiOx | Wacker DEHESIVE SF200 |
| XL | Wacker Crosslinker V90 |
| Cat | Wacker Catalyst OL |

### Influence of Antioxidant on Crosslinking of Silicone Coating Layer

Experiments were conducted to assess the influence of the antioxidant that is used in the polyethylene layer of the release liner on the cross-linking properties of the polysiloxane coating layer. To a quantity of Wacker DEHESIVE SF 200 vinylpolysiloxane, a heat-curable siloxane resin, a quantity of antioxidant according to the table below were added. The solutions were kept at room temperature for 3 days.

| Experiment | Antioxidant formulation |
|---|---|
| E1 | No antioxidant |
| E2 | 300 ppm AO1 |
| E3 | 1000 ppm AO1 |
| E4 | 300 ppm AO2 |
| E5 | 1000 ppm AO2 |
| E6 | 300 ppm AO3 |
| E7 | 1000 ppm AO3 |

Subsequently, in each of the experiments, 95.02 wt % of the solution, 3.93 wt % of Wacker Crosslinker V90 and 1.05 wt % of Wacker Catalyst OL were added. The solutions were poured onto a glass sheet to form a coating layer having a weight of 1 g/m², and subjected to a temperature of 120° C. during 15 sec. for curing. After curing, an extraction was performed using diisobutyl ketone for 24 hours.

The amount of vinylpolysiloxane in the diisobutylketone was determined using atomic adsorption spectroscopy. For each of the experiments, the fraction of extracted vinylpolysiloxane with regard to the total quantity of vinylpolysiloxane supplied was calculated. The fraction of extracted vinylpolysiloxane corresponds to the fraction of the vinylpolysiloxane that did not react during curing. For suitable application in release liners, the fraction of unreacted vinylpolysiloxane needs to be below 5 wt %. The fraction of unreacted vinylpolysiloxane for each of the experiments is shown in the table below.

| Experiment | E1 | E2 | E3 | E4 | E5 | E6 | E7 |
|---|---|---|---|---|---|---|---|
| % unreacted siloxane | 3.1 | 3.7 | 3.9 | 4.5 | 4.0 | 12.9 | 32.9 |

From the results above, it becomes apparent that the use of AO3 leads to excessive quantities of unreacted vinylpolysiloxanes, and therefore that AO3 is not suitable for use in release liner applications.

### Influence of Antioxidants on Polyethylene Film Properties

In order to assess the quality of the polyethylene formulations for use in films, tests were conducted using polyethylene formulations according to the table below.

| Experiment | Formulation |
|---|---|
| E8 | HDPE comprising 1150 ppm by wt of AO3 and 400 ppm |
| | by wt of AO2 |
| E9 | HDPE comprising 150 ppm by wt AO1 |
| E10 | HDPE comprising 40 ppm AO1 |

Of each of these formulations, films having a thickness of 25 μm were produced via film casting, using a 30 mm Gottfert extruder having an L/D ratio of 20, equipped with a three-zone screw with mixing elements, and a flat sheet die of 300 mm width. The cast film was inspected for gels using an OCS FSA 100 line scan camera. The detected gels were classified in size categories >300 μm, >450 μm, and >600 μm, and quantified in number of gels in each class per m² of film. The results are presented in the table below.

| | >300 μm | >450 μm | >600 μm |
|---|---|---|---|
| E8 | 10 | 4 | 2 |
| E9 | 5 | 2 | 0.6 |
| E10 | 8 | 3 | 1.5 |

From these gel count results, one can observe that the quantity of gels that occurred in films of the inventive compositions are reduced.

In the application concept of the release liners, it needs to be ascertained that the polyethylene layer is adhering sufficiently to a paper layer. If the adhesion of the polyethylene layer to the paper layer is not sufficient, certain fragments of the polyethylene and of the polysiloxane layer that is positioned underneath the polyethylene layer may remain on the adhesive surface of the object. In such case, it will be difficult to fully expose the adhesive surface of the object, which is necessary to optimally use the adhesive properties thereof.

In order to ascertain the adhesion of the polyethylene to the paper layer, several adhesion tests were performed. To a machine-glazed corona-treated paper having a weight of 80 g/m², polyethylene formulations comprising 80 wt % of the materials of each of the formulations E8-E10 and 20 wt % of the LDPE were applied via extrusion coating, using and extruder operating at a temperature of 190° C. at the hopper increasing to 320° C. at the die, having a residence time of 10 minutes. A coating having a weight of 20 g/m² was applied to the paper. The adhesion between the paper and the coating was determined upon conditioning for 24 hours according to ASTM D6677-18 by manual testing, the results of which are reported in the table below.

| Experiment | E8 | E9 | E10 |
|---|---|---|---|
| Adhesion | Good | Poor | Good |

From the results in the table above, it can be observed that the film of experiment E10 shows good adhesion to the paper substrate, as required for the release liner application.

Accordingly, the above results show that the formulation of example E10, using α-tocopherol as stabiliser, allows for production of a film which does not contain any materials that detrimentally affect the cross-linking of a polysilicone layer, that has desirably low gel content, and that has desirable adhesion properties to paper, thereby rendering such material appropriate for use in a polyethylene layer for release liners.

1. A composition comprising:
a) a polyethylene having a density of ≥940 and ≤970 kg/m³ as determined in accordance with ASTM D792 (2008); and
b) ≥10 and ≤100 ppm of α-tocopherol, with regard to the total weight of the composition.

2. The composition according to claim 1, wherein the composition comprises in total ≤5 ppm, of phosphorous-containing compounds.

3. The composition according to claim 1, further comprising:
c) a low-density polyethylene (LDPE) having a density of ≥900 and ≤935 kg/m³.

4. The composition according to claim 1, wherein the composition comprises ≥50.0 wt %, 9.93-4% of the polyethylene a), with regard to the total weight of the composition.

5. The composition according to claim 1, wherein the polyethylene a) has a melt mass-flow rate as determined in accordance with ISO 1133:2005 at 190° C. and 2.16 kg load of ≥1.0 and ≤15.0 g/10 min.

6. A laminate comprising in this order:
A) a paper layer;
B) a layer comprising the composition according to claim 1; and
C) a layer comprising a curable silicone resin formulation.

7. The laminate according to claim 6, wherein:
the paper has a grammage of ≥25 and ≤200 g/m²; and/or
the layer B) has a grammage of ≥5 and ≤50 g/m²; and/or
the layer C) has a grammage of ≥0.1 and ≤5.0 g/m².

8. The laminate according to claim 5, wherein the curable silicone resin formulation comprises a silicone resin, a cross-linking agent and a cross-linking catalyst.

9. The laminate according to claim 8, wherein the cross-linking agent is a hydropolysiloxane.

10. The laminate according to claim 8, wherein the cross-linking catalyst comprises a platinum-containing complex.

11. The laminate according to claim 8, wherein the silicone resin is a polysiloxane.

12. A process for the manufacturing of a cured laminate, the process comprising:
(i) providing a laminate comprising in this order:
A) a paper layer;
B) a layer comprising the composition according to claim 1; and
C) a layer comprising a curable silicone resin formulation;
and
(ii) subjecting the laminate to a curing process, wherein the curing process involves subjecting the laminate to a curing temperature, for a period sufficient for the curing to occur.

13. A cured laminate comprising in this order:
A) a paper layer;
B) a layer comprising the composition according to claim 1; and
C) a layer comprising a cured silicone resin formulation obtained by curing a curable silicone resin formulation comprising a silicone resin, a cross-linking agent and a cross-linking catalyst, wherein:
the cross-linking agent comprises a hydropolysiloxane;
the cross-linking catalyst comprises a platinum-containing complex; and
the silicone resin is a polysiloxane.

14. A protected object, wherein the protected object comprises
an object comprising an adhesive layer; and
a cured laminate according to claim 13;
wherein the adhesive layer of the object and the layer C) of the laminate are in contact with each other.

15. (canceled)
